(19) United States
(12) Patent Application Publication
(10) Pub. No.: US 2016/0358052 A1
(43) Pub. Date: Dec. 8, 2016

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Daisaku Moriwaki, Tokyo (JP)

(21) Appl. No.: 15/171,505

(22) Filed: Jun. 2, 2016

(30) Foreign Application Priority Data
Jun. 5, 2015 (JP) 2015-115173
Apr. 14, 2016 (JP) 2016-081489

(51) Int. Cl. G06K 15/02

(52) U.S. Cl. CPC G06K 15/1851; G06K 15/184; G06K 15/1817

(57) ABSTRACT

An information processing apparatus generates intermediate data to convert input print data into raster image data. The information processing apparatus includes a decoding unit configured to decode coded compression data of an image object to be drawn in an image based on the print data, and a rendering unit configured to generate raster image data by performing rendering for each region of the image with reference to image data of the image object stored by a storing unit. The decoding unit decodes compression data of an image object to be drawn in an interested region and at least a part of compression data of an image object to be drawn in a region following the interested region, while the rendering unit generates raster image data for the interested region.

### BACKGROUND OF THE INVENTION

Field of the Invention

The present invention relates to an information processing apparatus and an information processing method which are capable of generating image data from data described in page description language (PDL).

Description of the Related Art

Printing of an image on a recording medium includes receiving data described in PDL (hereinafter, referred to as “PDL data”) as print target data via a communication medium such as a network. To output the image from an image forming apparatus (e.g., a printer), raster image processor (RIP) processing is performed on the received PDL data to generate raster image data. More specifically, an interpreter dedicated to the image forming apparatus (e.g., the printer) to print the image interprets the received PDL data firstly. An intermediate data generation unit generates intermediate data based on interpretation result. Further, rendering processing is performed based on the intermediate data to generate the raster image data. The raster image data generated through the above-mentioned RIP processing is then subjected to predetermined image processing and converted into print data that can be printed by the image forming apparatus. The printer performs printing based on the print data. As a conventional method applicable to the above-mentioned printer system, it is conventionally known to reduce the capacity of a memory required to store intermediate data by generating the intermediate data for each of a plurality of belt-like regions obtainable by dividing image data of one page.

A conventional method discussed in Japanese Patent Application Laid-Open No. 2001-306275 includes dividing regions in such a manner that neighboring regions partly overlap if an image object straddles two adjacent regions, to generate intermediate data, when intermediate data is divided for each region. Further, another conventional method discussed in Japanese Patent Application Laid-Open No. 2003-72161 includes changing a division position if an image object straddles a plurality of regions.

In the RIP processing, in a case where compressed image data is included as an object in a rendering processing target region, the rendering processing cannot be started before expanding required compression data. Therefore, in the methods discussed in Japanese Patent Application Laid-Open No. 2001-306275 and Japanese Patent Application Laid-Open No. 2003-72161, an issue that it is required to wait for the expansion of the required image data each time the rendering processing is performed based on intermediate data generated for each region arises.

### SUMMARY OF THE INVENTION

The present invention is directed to an information processing apparatus, an information processing method, and a storage medium, which are capable of reducing waiting time before rendering processing required for respective regions when the rendering processing is performed based on intermediate data generated for each region.

According to an aspect of the present invention, an information processing apparatus that converts input print data representing a print target image into raster image data includes a decoding unit configured to decode coded compression data of an image object to be drawn in the image based on the print data, a first storing unit configured to store image data of the image object obtained as a result of the decoding of the compression data by the decoding unit, and a rendering unit configured to generate raster image data by performing rendering for each region of the image with reference to the image data of the image object stored by the storing unit, wherein, while the rendering unit generates raster image data for an interested region, the decoding unit decodes compression data of an image object to be drawn in the interested region and at least a part of compression data of an image object to be drawn in a region following the interested region.

Further features of the present invention will become apparent from the following description of exemplary embodiments with reference to the attached drawings.

### BRIEF DESCRIPTION OF THE DRAWINGS

FIG. 1 is a block diagram illustrating an entire configuration of an image forming apparatus.

FIG. 2A illustrates an example of a print target image.

FIG. 2B illustrates rendering bands and decoding bands of the print target image.

FIG. 3 is a block diagram illustrating a detailed configuration of a raster image data generation unit according to a first exemplary embodiment.

FIG. 4 illustrates print target image data and processing timings in raster image data generation processing.

FIG. 5 is a block diagram illustrating a detailed configuration of a PDL processing unit and illustrates an example of intermediate data.

FIG. 6A illustrates an example of rendering schedule.

FIG. 6B illustrates an example of dependence relationship between decoding band and rendering band.

FIG. 6C illustrates an example of decoding schedule.

FIG. 7A illustrates an example of regions for which intermediate data are generated.

FIG. 7B illustrates rendering processing based on intermediate data generated for each region.

FIG. 8 illustrates an example of the intermediate data.

FIG. 9 is a flowchart illustrating intermediate data generation processing and raster image data generation processing.

FIG. 10 is a flowchart illustrating intermediate data generation processing.

FIG. 11 is a flowchart illustrating details of precedent task generation processing.

FIG. 12 illustrates processing order in the raster image data generation processing according to the first exemplary embodiment.

FIG. 13 is a block diagram illustrating a detailed configuration of the PDL processing unit according to a second exemplary embodiment.

FIG. 14 is a flowchart illustrating intermediate data generation processing.

FIG. 15 is a flowchart illustrating processing performed by the PDL processing unit and the raster image data generation unit.

### DESCRIPTION OF THE EMBODIMENTS

Hereinafter, exemplary embodiments of the present invention will be described in detail with reference to the attached drawings. Configurations described in the following exemplary embodiments are mere examples. The present invention is not limited to the illustrated configurations.

### (Entire Configuration)

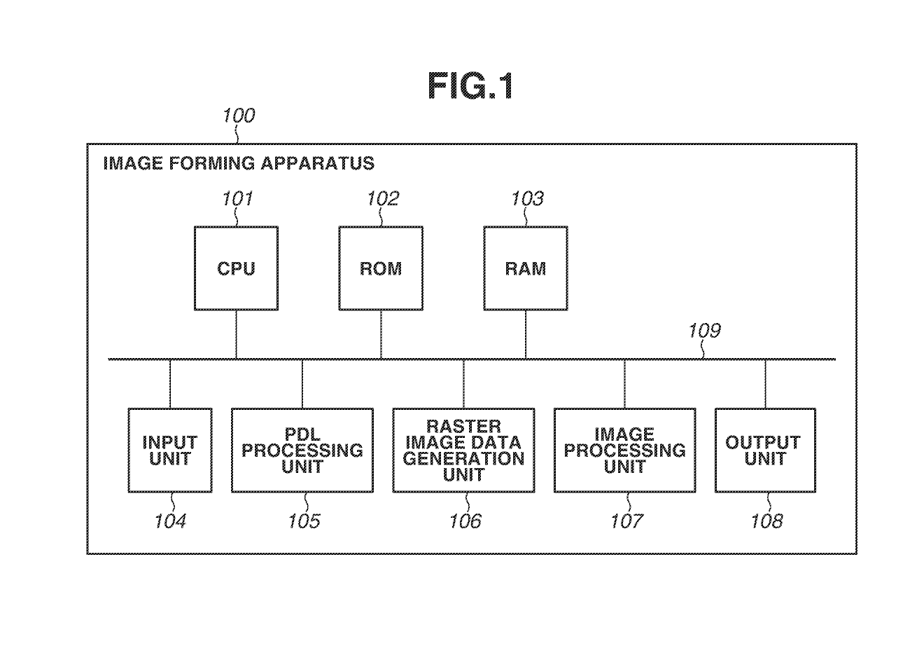

FIG. 1 is a block diagram illustrating an entire configuration of an image forming apparatus 100 according to a first exemplary embodiment. The image forming apparatus 100 includes a central processing unit (CPU) 101, a read only memory (ROM) 102, a random access memory (RAM) 103, an input unit 104, an image processing unit 107, and an output unit 108. The image forming apparatus 100 further includes a PDL processing unit 105 and a raster image data generation unit 106, which cooperatively constitute an information processing apparatus. The above-mentioned constituent components of the image forming apparatus 100 are mutually connected via a bus 109.

The CPU 101 controls calculation processing and operations performed by respective constituent components of the image forming apparatus 100 by reading programs from the ROM 102 and executing the programs. The RAM 103 is a readable and writable memory, i.e., a storage medium that can temporarily store various data (including image data). The input unit 104 receives, as print target data, data described in page description language (hereinafter, referred to as PDL data) transferred from a host PC or a server (not illustrated) and stores the PDL data in the RAM 103.

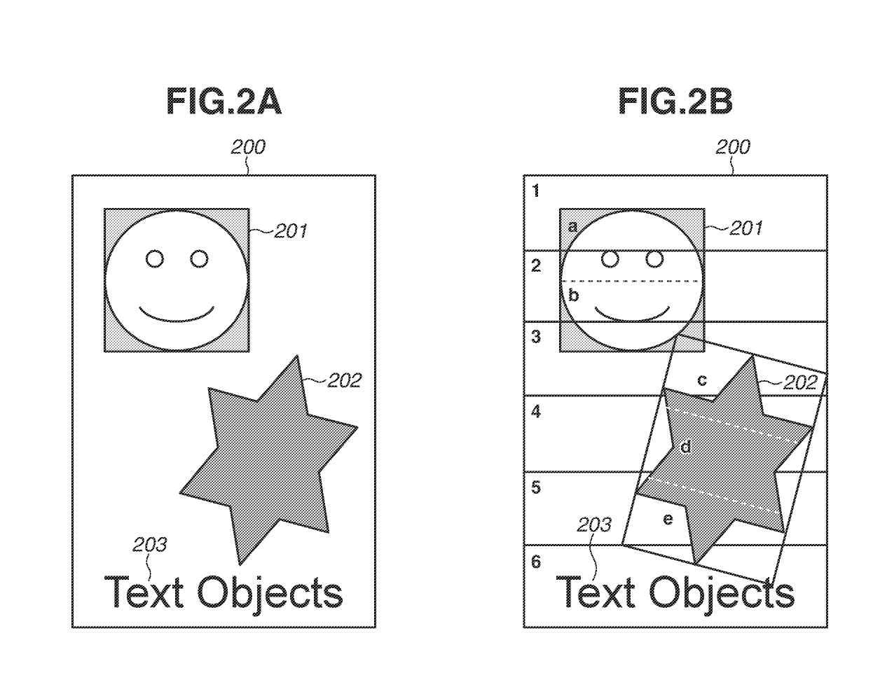

The PDL processing unit 105 analyzes PDL data of each page received by the input unit 104 and converts the PDL data into intermediate data. The PDL data includes object information about print target data of each page and includes object drawing position information. A print page 200 illustrated in FIG. 2A is an example of the print target data. The print page 200 includes an image object 201, an image object 202, and a text object 203. The PDL data for the print page 200 includes information required to reproduce each object and drawing position of each object. More specifically, the PDL data for the print page 200 includes compression data of respective image objects 201 and 202, color and type information about the text, and background color information. In general, PDL data is configured as a file in various formats. Therefore, the PDL processing unit 105 converts the PDL data into the intermediate data having an appropriate format that can be processed by the raster image data generation unit 106 of the image forming apparatus 100. In this case, the PDL processing unit 105 also generates schedule data required to control the timings of rendering processing and decoding processing to be performed by the raster image data generation unit 106 and outputs the schedule data as a part of the intermediate data.

The raster image data generation unit 106 generates raster image data based on the intermediate data generated by the PDL processing unit 105. The PDL processing unit 105 and the raster image data generation unit 106 will be described in detail below.

The image processing unit 107 generates print data by performing predetermined image processing on the raster image data generated by the raster image data generation unit 106. The output unit 108 is an inkjet-type or electrophotographic-type printer engine. The output unit 108 forms an image on a recording medium based on the print data generated by the image processing unit 107.

### (Detailed Configuration of Raster Image Data Generation Unit 106)

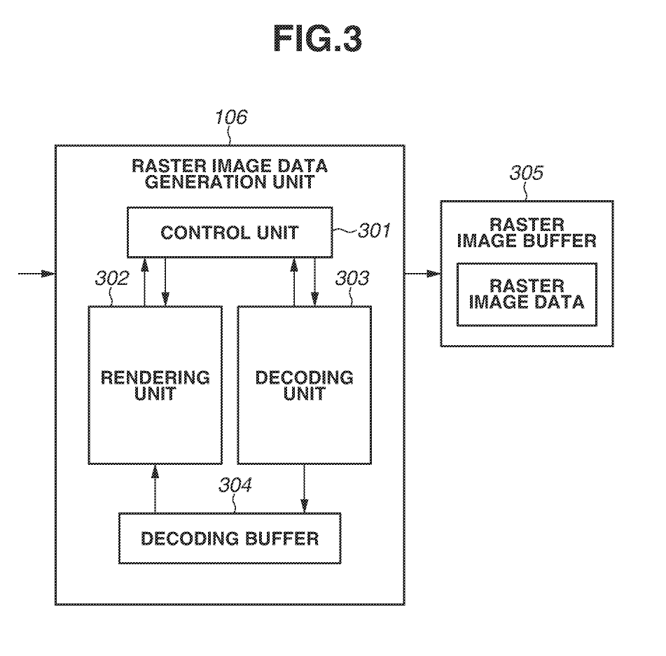

First, a detailed configuration of the raster image data generation unit 106 will be described below with reference to FIG. 3. In the present exemplary embodiment, the raster image data generation unit 106 includes a control unit 301, a rendering unit 302, and a decoding unit 303. The raster image data generation unit 106 further includes a decoding buffer 304 that stores various data. In the present exemplary embodiment, the CPU 101 is functionally operable as the rendering unit 302 and the decoding unit 303 when the CPU 101 executes corresponding computer programs. However, the present invention is not limited to the above-mentioned example. A dedicated hardware, such as an application specific integrated circuit (ASIC) or an electronic circuit, is usable to constitute a part or the whole of the above-mentioned configuration.

The rendering unit 302 performs rendering processing for each band having being preliminarily set, based on the intermediate data. FIG. 2B illustrates a plurality of regions to which reference numbers 1 to 6 are allocated. Each of the regions 1 to 6 is a minimum region that is to be independently subjected to the rendering processing performed by the rendering unit 302. The regions 1 to 6 are hereinafter referred to as “rendering bands”. The height of each rendering band is comparable to a predetermined number of pixels in an output space of the print page 200. The width of each rendering band is comparable to the page width. The height of each rendering band is set beforehand according to the processing speed and/or the capacity of a memory that can store the generated raster image data.

The decoding unit 303 decodes image data of an image object, which is a part of objects to be drawn on the print page, having been compressed according to a predetermined coding format (hereinafter, referred to as compression data). In the present exemplary embodiment, the decoding unit 303 reads compression data of the image objects 201 and 202, if necessary, and decodes each compression data having a predetermined height preliminarily set. In the present exemplary embodiment, the minimum region of an image object that is independently decoded is referred to as “decoding band”. FIG. 2B illustrates five minimum regions “a”, “b”, “c”, “d”, and “e” that can be independently processed by the decoding unit 303. The decoding bands “a” and “b” are two divided regions that cooperatively constitute the image object 201. The decoding bands “c”, “d”, and “e” are three divided regions that cooperatively constitute the image object 202. Performing the decoding processing for each decoding band brings the following effects. For example, when the decoding unit 303 processes the rendering band 1, the area to be subjected to the decoding processing is approximately a half of the entire image object 201. Therefore, performing the decoding processing for each decoding band can increase the efficiency of the decoding processing and can reduce the capacity of the decoding buffer 304. The height of each decoding band is set according to the capacity of the decoding buffer 304 that stores the decoded image data. The decoding buffer 304 can hold the image data decoded for each decoding band. In the present exemplary embodiment, the storage capacity of the decoding buffer 304 is comparable to the data of three decoding bands.

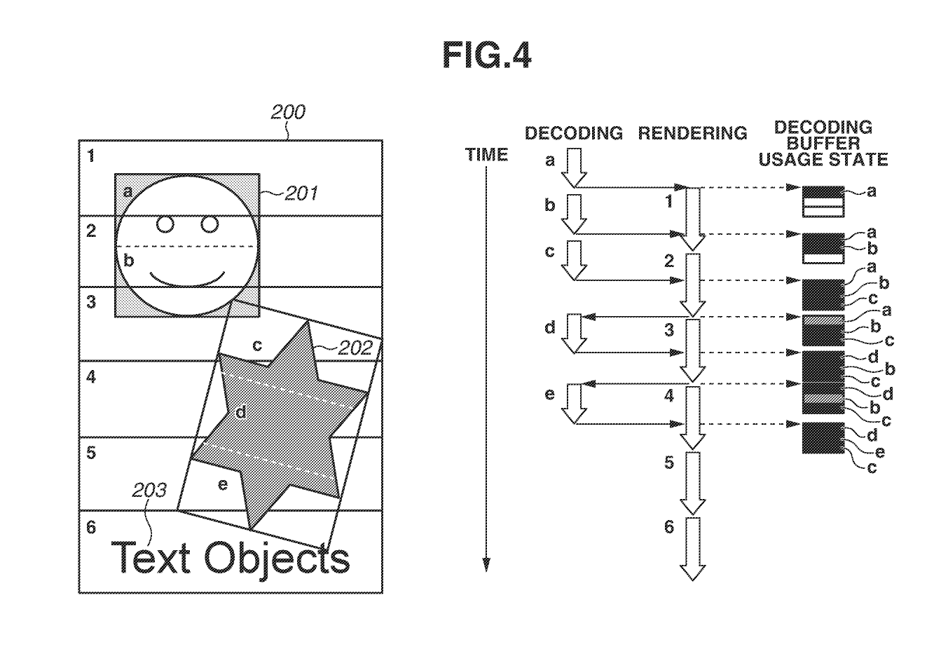

Hereinafter, the processing order of the rendering processing and the decoding processing will be described in detail below with reference to FIG. 4. The rendering unit 302 can start the rendering processing for a processing target rendering band after the decoding of the compression data necessary for the processing target rendering band has been entirely completed. More specifically, after the decoding of the decoding band “a” required for the rendering band 1 has been completed, the rendering unit 302 can start rendering processing for the rendering band 1.

On the other hand, while the rendering unit 302 is performing the rendering processing, the decoding unit is prohibited to rewrite or delete the image data to be drawn in the currently processed rendering band from the decoding buffer 304. At the completion timing of the decoding of the decoding band “c” performed by the decoding unit 303, the data stored in the decoding buffer 304 is the image data of the decoding bands a, b, and c. In other words, there is not any available capacity of the decoding buffer 304. The image data of the decoding bands “a” and “b” is necessary for the rendering band 2, which is currently processed by the rendering unit 302. The image data of the decoding band “c” becomes necessary for the rendering band 3 to be next subjected to the rendering processing. Therefore, the decoding unit 303 waits for the completion of the rendering processing for the rendering band 2 currently performed by the rendering unit 302. If the processing of the rendering unit 302 proceeds to the rendering band 3, the decoding unit 303 starts decoding the decoding band “d”. The decoding unit 303 overwrites the image data storage area of the decoding buffer, corresponding to the decoding band “a”, by the decoded image data of the decoding band “d”.

As mentioned above, there is a dependence relationship between the rendering processing and the decoding processing with respect to the possibility of starting the processing. When the capacity of the decoding buffer 304 is comparable to three decoding bands, it means that the image data of three decoding bands can be drawn in one rendering band. Therefore, in designing the capacity of the decoding buffer 304, the maximum number of decoding bands that can be drawn in one rendering band and the cost of the memory capacity are both taken into consideration.

The control unit 301 can control processing to be performed by the rendering unit 302 and the decoding unit 303 based on the intermediate data. The intermediate data includes information about the decoding band required in the processing for each rendering band and information about the rendering band that does not require any decoding band. The control unit 301 reads the above-mentioned information from the intermediate data, instructs the rendering unit 302 and the decoding unit 303 to start the processing, and receives processing completion notifications. The intermediate data will be described in detail below.

### (Detailed Configuration of PDL Processing Unit 105)

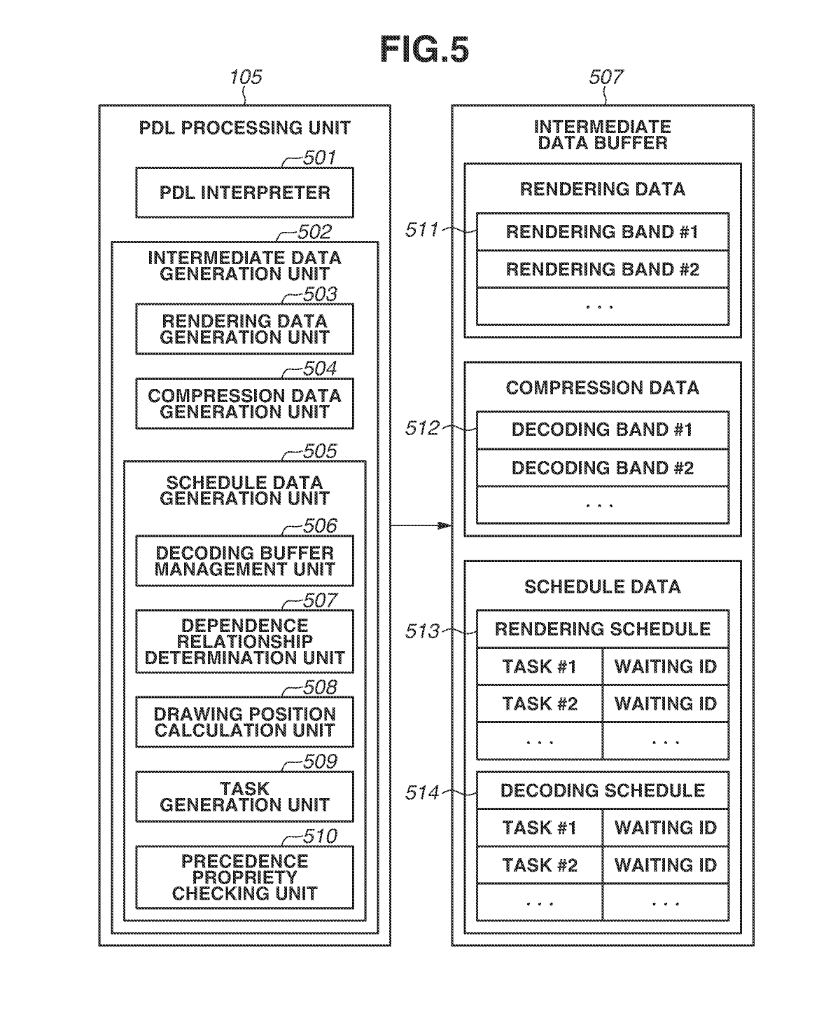

A detailed configuration of the PDL processing unit 105 and intermediate data will be described in detail below with reference to FIG. 5. When the CPU 101 executes a computer program, the PDL processing unit 105 is functionally operable as respective processing units illustrated in FIG. 5. The PDL processing unit 105 can generate intermediate data having a format that can be processed by the raster image data generation unit 106, as described above, based on PDL data of one page. The PDL processing unit 105 includes a PDL interpreter 501 and an intermediate data generation unit 502. The PDL interpreter 501 can interpret PDL data, convert the PDL data into a drawing command, and output the drawing command to the intermediate data generation unit 502.

The intermediate data generation unit 502 includes a rendering data generation unit 503, a compression data generation unit 504, and a schedule data generation unit 505. The rendering data generation unit 503 can generate rendering data 511 having a format that can be processed by the rendering unit 302, for each rendering band, based on the drawing command interpreted by the PDL interpreter 501. As described above, each rendering band is a partial region in an output space of the print page. Each rendering band can be defined by a print page width in the main scanning direction and a print page height in the sub scanning direction. For example, the print page height is comparable to a predetermined number of pixels (e.g., 64 pixels).

The rendering data 511 includes region information included in the rendering band and object information required to draw an object in each region. As described above, the object information includes color information required to draw a monochrome region and image information required to draw an image object in the region. In a case where an image object straddles a plurality of rendering bands, the information about the image object is included in rendering data corresponding to these rendering bands. However, the drawing position of an image object in the raster image data and a region of the image object to be used for the drawing are different in each rendering band. According to the example illustrated in FIG. 2A, the rendering data generation unit 503 generates rendering data for each of six rendering bands. The rendering unit 302 sequentially reads rendering data designated according to an instruction from the control unit 301 and performs rendering processing on the designated rendering data to generate raster image data.

The compression data generation unit 504 can read compression data, i.e., data having been preliminarily compressed and formatted according to a drawing command, and can convert the read compression data into compression data 512 having a format that can be processed by the decoding unit 303 for each decoding band. In the present exemplary embodiment, each decoding band is a partial region in a two-dimensional space of image data held as the compression data. Each decoding band can be defined by an image width in the horizontal direction and an image height in the vertical direction. For example, the image height is comparable to 64 pixels. When the processing target is the print page 200 illustrated in FIG. 2A, the compression data generation unit 504 divides respective image objects into decoding bands a, b, c, d, and e to generate the compression data 512.

The schedule data generation unit 505 can generate scheduling data that is required to control a rendering processing timing and a decoding processing timing according to a drawing command. The scheduling data includes a rendering schedule 513 that is required to control the timing of the rendering processing to be performed by the rendering unit 302 and a decoding schedule 514 that is required to control the timing of the decoding processing to be performed by the decoding unit 303. The schedule data generation unit 505 includes a decoding buffer management unit 506, a dependence relationship determination unit 507, a drawing position calculation unit 508, a task generation unit 509, and a precedence propriety checking unit 510.

The rendering schedule 513 is composed of a plurality of tasks, each indicating identification information about each rendering band, and corresponding waiting IDs, each indicating identification information about a decoding band associated with each task, which are arranged according to the order in the rendering processing. The rendering task indicates identification information about a target rendering band to be processed by the rendering unit 302. Further, the waiting ID indicates identification number of the last decoding band decoding for which the decoding unit 303 should complete before the rendering unit 302 starts processing for the processing target rendering band. For example, according to the print page 200 illustrated in FIG. 2B, the rendering band 3 includes image data of two decoding bands b and c. Respective image objects are sequentially decoded according to the drawing order determined with reference to the drawing positions thereof. Therefore, the decoding band c (i.e., the band to be later decoded) is associated with waiting ID corresponding to the task of the rendering band 3.

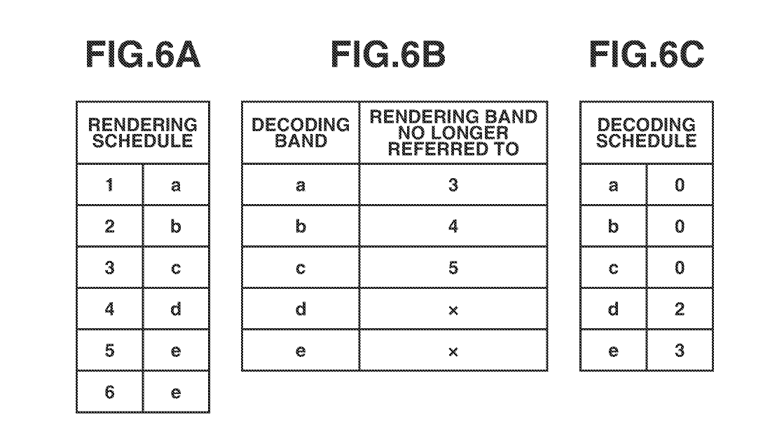

FIG. 6A illustrates a rendering schedule for the rendering processing illustrated in FIG. 4. If the waiting ID of a rendering task is 0, it means promptly executing the rendering for its rendering band. The control unit 301 of the raster image data generation unit 106 sequentially reads the contents of the rendering schedule. The control unit 301 refers to the rendering schedule 513 and confirms whether the decoding processing for the waiting ID corresponding to a processing target rendering band is already completed. After confirming the completion of the decoding processing, the control unit 301 instructs the rendering unit 302 to start rendering processing for the processing target rendering band.

First, the drawing position calculation unit 508 calculates the drawing position of an image object in the raster image data based on a drawing command obtained from a PDL interpreter 201. In a case where the data format of a drawing target object is compression data, the task generation unit 509 determines a decoding band to be drawn in each rendering band based on the calculated drawing position. The task generation unit 509 associates the determined decoding band with each waiting ID and generates a task based on the associated data. Then, the task generation unit 509 outputs the rendering schedule 513.

On the other hand, the decoding schedule 514 is composed of a decoding task indicating identification information about a decoding band and a waiting ID indicating identification information about a rendering band associated with each decoding task. If the waiting ID is 0, it means promptly executing the corresponding decoding task. On the other hand, if the waiting ID is not 0, it means executing the task after completing a rendering task of the rendering band indicated by the waiting ID.

The control unit 301 sequentially reads the contents of the decoding schedule 514 from the top thereof. If the control unit detects the completion of rendering processing for a rendering band indicated by the waiting ID of a read decoding band, the control unit instructs starting decoding processing for the read decoding band.

The dependence relationship determination unit 507 can calculate a drawing end position of an image object on the raster image data based on the drawing command obtained from the PDL interpreter 201. The dependence relationship determination unit can determine a rendering band where each decoding band is no longer referred to, based on the calculated drawing end position. Further, the dependence relationship determination unit can store a determined result as a dependence relationship between the decoding band and the rendering band. The decoding buffer management unit 506 preliminarily holds information indicating the number of decoding bands that can be stored by the decoding buffer 304. The decoding buffer management unit 506 can manage a usage state (or availability) of the decoding buffer 304. For each task indicating identification information about a decoding band, the task generation unit 509 can generate the task in association with a corresponding rendering band that serves as a task start index, with reference to the availability of the decoding buffer 304.

FIG. 6B illustrates an example of the dependence relationship between each decoding band and a corresponding rendering band where the decoding band is no longer referred to, which has been calculated based on the print page illustrated in FIG. 2B. Respective decoding bands are sequentially arranged from the top with reference to their drawing positions. More specifically, the decoding band “a” is a decoding band to be decoded first. Therefore, after the rendering processing for the rendering band 3 starts, a storage area for the decoding band “a” becomes available as an overwritable capacity of the decoding buffer 304. The task generation unit 509 determines the waiting ID of each decoding band with reference to the rendering band where each decoding band is no longer referred to. FIG. 6C illustrates a determined result of the generated decoding schedule. In the present exemplary embodiment, the storage capacity of the decoding buffer 304 is three decoding bands. Therefore, information that can be immediately stored in the decoding buffer 304 are decoding results of the decoding bands a, b, and c. It is unnecessary to wait until a part of the decoding buffer 304 becomes vacant. Accordingly, the task generation unit 509 sets the waiting ID for respective decoding bands a, b, and c to 0. The recording result of the decoding band “d” can be stored in the decoding buffer 304 after the storage area for the decoding band “a” is released. After the rendering processing for the rendering band 3 starts, the storage area for the decoding band “a” becomes available as an overwritable capacity. Therefore, the task generation unit 509 determines the rendering band 2 as the waiting ID of the decoding band “d”.

As mentioned above, the intermediate data generation unit 502 can generate intermediate data. The intermediate data buffer 507 can store the generated intermediate data.

### (Generation of Intermediate Data of Respective Divided Regions)

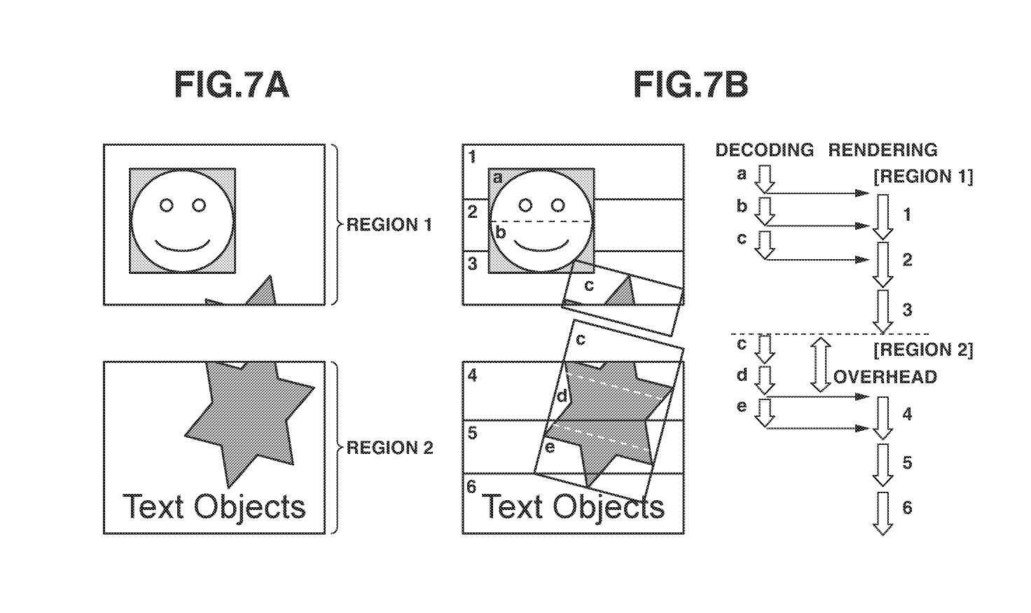

The intermediate data 506 is composed of the rendering data, the compression data, and the schedule data as described above. The data amount of the intermediate data 506 may become larger excessively. Therefore, to reduce the memory capacity of the intermediate data buffer 506, the intermediate data generation unit 502 can generate intermediate data of each region of the print page, as described in detail below. FIG. 7A illustrates a region 1 and a region 2 that can be obtained by dividing the print page 200 in the horizontal direction.

First, processing for generating intermediate data for each region according to a method similar to that for generating intermediate data without dividing a print page will be described in detail below with reference to FIG. 6B. The intermediate data generation unit 502 interprets PDL data of the region 1 and generates intermediate data of the region 1. The intermediate data buffer 507 stores the generated intermediate data. More specifically, the intermediate data generation unit 502 generates the rendering data 511 corresponding to three rendering bands of the region 1. Further, the intermediate data generation unit 502 generates three compression data 512 of the decoding bands “a” and “b” corresponding to the entire region of the image object 201 and the decoding band c corresponding to a part of the image object 202. The raster image data generation unit 106 performs decoding and rendering processing for the rendering bands 1, 2, and 3 and the decoding bands a, b, and c, which cooperatively constitute the region 1, based on the intermediate data of the region 1. Once the rendering processing for the rendering band 3 (i.e., the last task) has been started, the intermediate data buffer 506 can be brought into an overwritable state.

The intermediate data generation unit 502 interprets PDL data of the region 2 and generates intermediate data of the region 2. The intermediate data buffer 507 stores the generated intermediate data. More specifically, the intermediate data generation unit 502 generates the rendering data 511 corresponding to three rendering bands of the region 2. Further, the intermediate data generation unit 502 generates three compression data 212 of the decoding bands c, d, and e corresponding to the entire region of the image object 202. The raster image data generation unit 106 reads the intermediate data of the region 2 from the intermediate data buffer 506 and performs rendering processing and decoding processing for the rendering bands 4, 5, and 6 and the decoding bands c, d, and e.

As mentioned above, in the case where the generation of intermediate data is performed for each region, it is required to initially perform the decoding processing for a decoding band required for a rendering band to be initially subjected to the rendering processing for the region 2. As a result, in the case where the generation of intermediate data is performed for each region of the print page corresponding to one page, the waiting time required to complete the decoding of an image object required in the drawing may increase, compared to the case where the generation of intermediate data is performed without any division. The waiting time for the decoding processing applied to the region 2 (namely, the processing time required to complete the print) becomes longer compared to the non-division case illustrated in FIG. 4. This is the reason why undesirable overhead is caused.

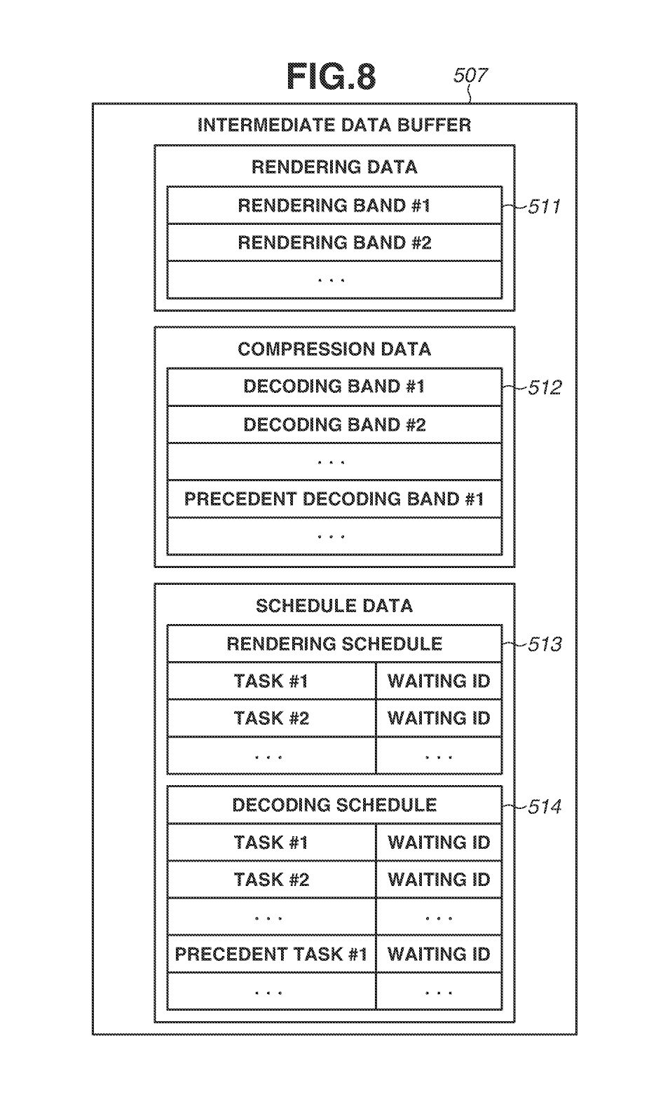

Therefore, the present exemplary embodiment includes processing for generating schedule data with reference to PDL data required for a region not included in the intermediate data, according to the usage state of the decoding buffer, in a case where the generation of intermediate data is performed for each region of the print page corresponding to one page. More specifically, if an interested region is a region for which intermediate data is to be generated, the apparatus according to the first exemplary embodiment precedently decodes at least a part of decoding bands of an image object to be drawn in a region other than the interested region. Therefore, the precedence propriety checking unit 510 checks if compression data required for an initially rendered rendering band of a region to be processed next is precedently decodable, with reference to PDL data of the region to be processed next. FIG. 8 illustrates an example of the intermediate data of each region generated by the schedule data generation unit 505.

The task generation unit 509 generates a decoding schedule for precedently decoding target compression data in a region to be processed next according to a checking result obtained by the precedence propriety checking unit 510. Further, the task generation unit 509 generates the compression data of a decoding band to be precedently decoded as precedent decoding band. More specifically, in the present exemplary embodiment, in the case where the generation of intermediate data is performed for each region, the generated intermediate data includes a decoding band of a region for which intermediate data is next generated and a precedent task including decoding of the region for which intermediate data is next generated as identification information. The precedent decoding band included in the compression data is compression data of an image object not drawn in the interested region.

### (Flow of Entire Processing Performed by Information Processing Apparatus)

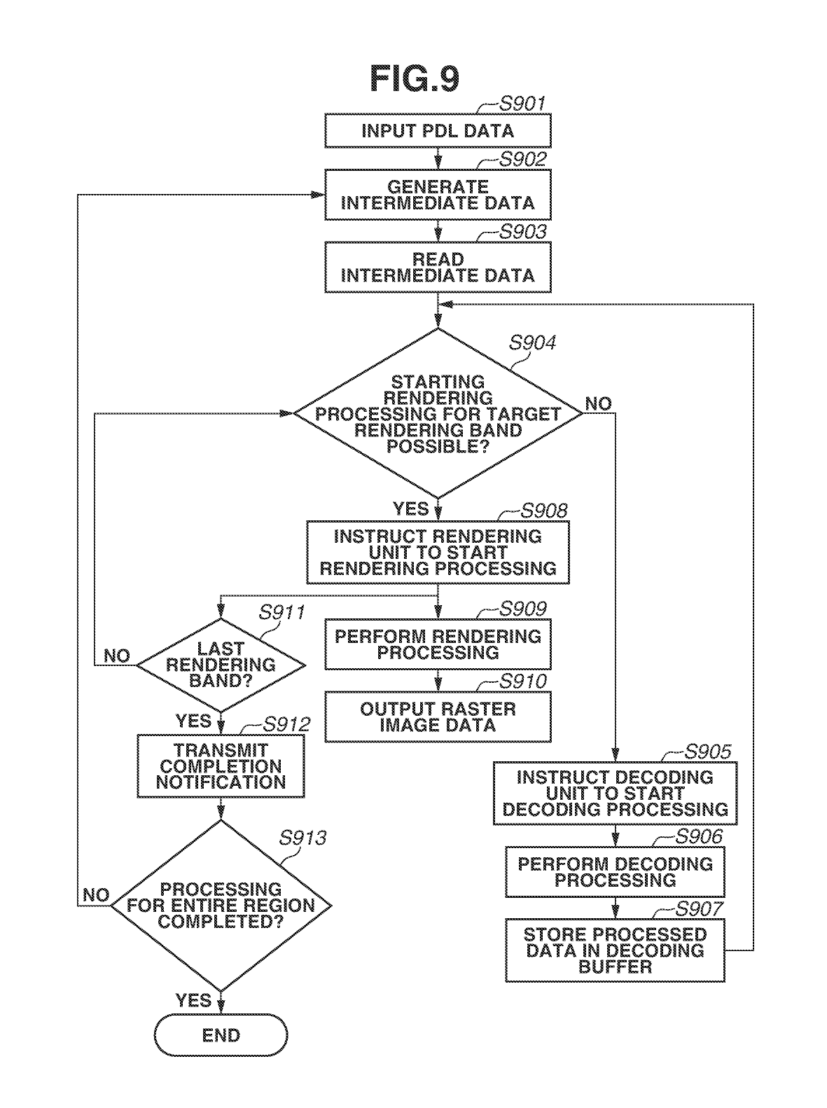

A flow of the entire processing performed by the PDL processing unit 105 and the raster image data generation unit 106, which are functionally operable as the information processing apparatus, will be described below. FIG. 9 is a flowchart illustrating the entire processing performed by the PDL processing unit 105 and the raster image data generation unit 106. To realize the functions of respective processing units, the CPU 101 reads a program that can realize the flowchart illustrated in FIG. 9 and perform processing based on the program.

First, in step S901, print target PDL data is input to the PDL processing unit 105. In step S902, the PDL processing unit 105 generates and outputs intermediate data for each region based on PDL data of a predetermined region. First, the PDL interpreter 501 interprets a partial PDL data of the PDL data and converts the interpreted PDL data into a drawing command. The intermediate data generation unit 502 generates intermediate data according to the drawing command interpreted by the PDL interpreter 501. The intermediate data generation processing to be performed in step S902 will be described in detail below. The generated intermediate data can be stored in the intermediate data buffer 507 of the RAM 103. The PDL processing unit 105 transmits a completion notification to the CPU 101 upon completing the generation of intermediate data of the region.

In step S903, the control unit 301 of the raster image data generation unit 106 reads the intermediate data from the intermediate data buffer 507. In step S904, the control unit 301 read a task to be processed with reference to a rendering schedule included in the read intermediate data and determines a processing target rendering band. The control unit 301 determines whether it is possible to start rendering processing for the processing target rendering band with reference to waiting ID of the task. If the control unit 301 determines that the waiting ID is 0 or if the decoding processing for the decoding band indicated by the waiting ID is already completed (YES in step S904), the operation proceeds to step S908. If the control unit 301 determines that the decoding processing for the decoding band indicated by the waiting ID is not yet completed (NO in step S904), the operation proceeds to step S905.

In step S905, the control unit 301 instructs the decoding unit 303 to start decoding processing and complete the decoding processing for the decoding band described in the waiting ID of the processing target task. In step S906, the decoding unit 303 reads compression data included in the intermediate data according to an instruction from the control unit 301 and sequentially decodes the compression data until the processing for the instructed decoding band completes. In step S907, the decoding unit 303 stores the image data obtained through the decoding processing in the decoding buffer 304.

If the control unit 301 detects the completion of the decoding processing for the decoding band indicated by the waiting ID of the processing target task (Yes in step S904), then in step S908, the control unit 301 causes the rendering unit 302 to start rendering processing for the rendering band corresponding to identification information included in the task. In step S909, the rendering unit 302 starts rendering the rendering band instructed by the control unit 301. If image data decoded in the processing target rendering band is required, the rendering unit 302 reads it from the decoding buffer 304. In step S910, the rendering unit 302 outputs raster image data having been generated through the rendering processing.

If the rendering processing instruction in step S908 is completed, then in step S911, the control unit 301 determines whether the start instructed rendering band is the last rendering band to be subjected to the rendering processing. If the start instructed rendering band is the last rendering band, it means that the decoding unit 303 has completed the decoding of all decoding bands. Further, the intermediate data buffer 507 becomes available for overwriting after the reading of rendering data of the last rendering band from the rendering unit 302 is completed. Therefore, if the start instructed rendering band is the last rendering band (Yes in step S911), then in step S912, the control unit 301 transmits a completion notification.

In step S913, the PDL generation unit 102 determines whether the generation of intermediate data has been completed for the entire region of the print page. If it is determined that there is a region for which intermediate data is not yet generated (No in step S913), the operation returns to step S902. The PDL processing unit 105 generates intermediate data of the next region.

### (Flow of Processing Performed by Intermediate Data Generation Unit 502)

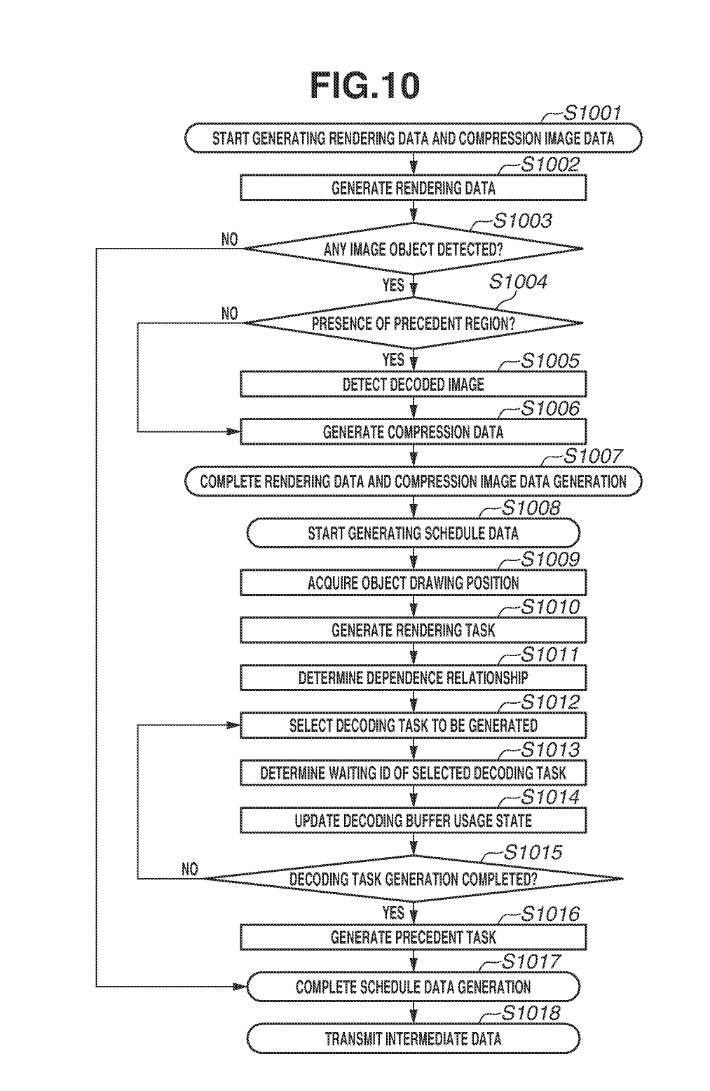

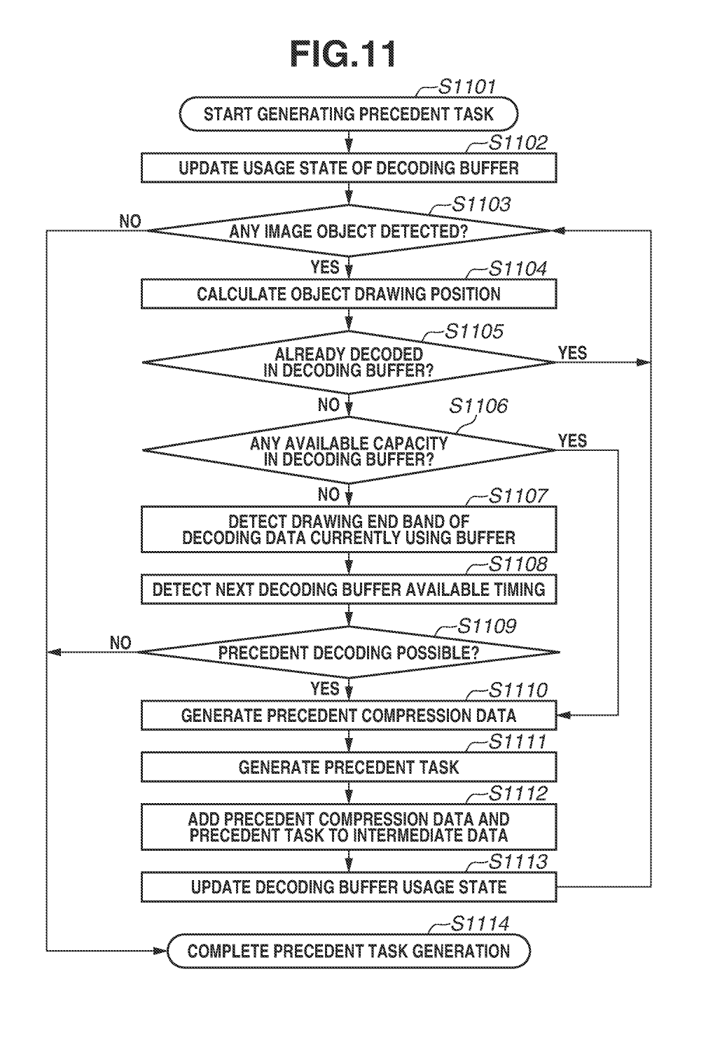

The intermediate data generation processing performed by the intermediate data generation unit 502 in step S902 will be described in detail below with reference to a flowchart illustrated in FIG. 10. FIG. 11 is a flowchart illustrating details of precedent task generation processing to be performed by the task generation unit 509 and precedent decoding band generation processing to be performed by the compression data generation unit 504.

First, in step S1001, the CPU 101 causes the intermediate data generation unit 502 to start generating rendering data and compression image data. As described above, the intermediate data generation unit 502 divides the print page into the region 1 and the region 2 before generating intermediate data. Hereinafter, it is assumed that the intermediate data of the region 1 has been generated. In step 1002, the rendering data generation unit 503 generates rendering data for each rendering band having a predetermined height.

In step S1003, the compression data generation unit 504 determines whether the raster image data includes any object to be drawn. If there is not any image object to be drawn (No in step S1003), only the rendering data is the intermediate data. The operation proceeds to step S1016. If the compression data generation unit 504 determines that there is an image object to be drawn (Yes in step S1003), the operation proceeds to step S1004. If the processing target region is the first region, such as the region 1 (No in step S1004), the operation proceeds to step S1006. The compression data generation unit 504 converts the detected image object into compression data of each decoding band having a predetermined height. Though the above-mentioned processing, the rendering data of three rendering bands and the compression data of three decoding bands to be drawn in the region 1 can be generated for the region 1. If the processing target region is a region to be processed after a precedent region, such as the region 2 (Yes in step S1004), the operation proceeds to step S1005. In step S1005, the intermediate data generation unit 502 determines whether the decoding buffer 304 stores any decoding band already decoded in the precedent region. More specifically, the intermediate data generation unit 502 determines whether the detected image object has been already decoded in the precedent region by referring to information about decoding buffer usage state stored in the decoding buffer management unit 506. The precedently decoded image object is excluded from the generation of compression data. Namely, compression data generation target is an image object that is not yet decoded. In step S1006, the intermediate data generation unit 502 converts the compression data generation target into compression data.

In step S1007, if completion of the processing for generating the rendering data and the compression data has been detected, the operation proceeds to step S1008. In step S1008, the intermediate data generation unit 502 instructs the schedule data generation unit 505 to start generating schedule data.

In step S1009, first, the drawing position calculation unit 508 calculates an object drawing position. In step S1010, the task generation unit 509 associates the finally drawn decoding band with the waiting ID, for each rendering band. For example, in the rendering band 2 illustrated in FIG. 2B, the decoding band “b” is positioned backward than the decoding band “a” in the raster order. Therefore, the task generation unit 509 associates the decoding band “b” with the rendering band 2 and sets it as the waiting ID. The task generation unit 509 sets the waiting ID for a task of all rendering bands and then outputs the set data as the rendering schedule.

In step S1011, the dependence relationship determination unit 815 determines a dependence relationship between the decoding band and the rendering band. The dependence relationship is a correspondence relationship between a decoding band and a rendering band at which referring to the image data of the decoding band is ceased. The dependence relationship determination unit 507 refers to a drawing end position of each decoding band and associates the decoding band with a rendering band to be rendered next to the rendering band of the end position.

In step S1012, the task generation unit 509 selects a decoding band according to the drawing order and sets identification information about the selected decoding band as a task. In step S1013, the task generation unit 509 determines waiting ID of the selected decoding band with reference to the dependence relationship between the decoding band and the rendering band as well as the availability of the decoding buffer 304 managed by the decoding buffer management unit 506. If there is an available capacity in the decoding buffer 304, the task generation unit 509 sets the waiting ID to 0 because it is unnecessary to wait for the completion of rendering with respect to the selected decoding band. Further, if there is not any available capacity in the decoding buffer 304, the task generation unit 509 detects a rendering band that can provide an available capacity if the rendering processing thereof completes, with reference to the dependence relationship. The task generation unit 509 designates the rendering band capable of providing the available capacity as waiting ID. For example, if the selected band is the decoding band “d”, there is not any available capacity because the entire storage area of the decoding buffer 304 is occupied with the image data of the decoding bands a, b, and c. As understood from the dependence relationship, the decoding band “a” (i.e., the leading part of the stored decoding bands) is no longer referred to after the processing has proceeded to the rendering band 3. Therefore, the task generation unit 509 determines the rendering band 3 as the waiting ID of the task of the decoding band “d”.

In step S1014, the decoding buffer management unit 506 updates the usage state of the decoding buffer 304 with reference to the determined decoding task and the waiting ID. The decoding buffer management unit 506 preliminarily holds information about the number of decoding bands that the decoding buffer 304 can store. If the waiting ID of the decoding task is set to 0 in step S1013, the decoding buffer management unit 506 stores the fact that the available capacity decreases by 1 at the decoding task start timing. Further, with reference to the dependence relationship of the decoding task in step S1013, at the timing of the completion of a rendering band that is no longer referred to, the decoding buffer management unit 506 increases the available capacity by the number of decoding bands each having the dependence relationship with the rendering band.

In step S1015, the task generation unit 509 determines whether the decoding task generation has been completed for all decoding bands. If the task generation unit 509 determines that the task generation for all decoding bands is not yet completed (No in step S1015), the operation returns to step S1012. If the task generation unit 509 determines that the task generation for all decoding bands has been completed (Yes in step S1015), the operation proceeds to step S1016.

In step S1017, the task generation unit 509 generates a precedent task in order to precedently decode an image object to be drawn in a region where intermediate data is to be next generated. The precedent task generation processing will be described in detail below. The generated precedent task is disposed as a part of the decoding schedule in such a manner as to follow the task generated in step S1013, as understood from FIG. 8.

In step 1018, the intermediate data generation unit 502 transmits the intermediate data generated through the above-mentioned processing to the intermediate data buffer 507 and completes the processing for generating the intermediate data of the region 1.

The precedent task generation processing performed in step S1016 will be described in detail below with reference to FIG. 11. First, in step S1102, the decoding buffer management unit 506 updates the usage state of the decoding buffer at the completion timing of all decoding tasks in the region where the intermediate data has been generated. More specifically, all decoding tasks in the region 1 completes when the decoding of the decoding band “c” completes and the task processing for the rendering band 2 is in progress. In this case, the image data of the decoding bands “a” and “b” is required for the rendering band 2. Therefore, there is not any capacity that is available for overwriting. Therefore, the decoding buffer management unit 506 updates the available capacity of the buffer to 0, as information at the completion timing of the decoding of the decoding band “c”.

Next, in step S1103, the task generation unit 509 detects an image object to be drawn in a region for which intermediate data is to be next generated with reference to the drawing command of the region for which intermediate data is to be next generated, sequentially from a head rendering band until the image object is detected. In the present exemplary embodiment, the task generation unit 509 refers to the drawing command of the region 2 and detects that the decoding band “c” and the decoding band “d” are drawn in the first band of the region 2.

In step 1104, the drawing position calculation unit 508 calculates a rendering band where the drawing of the detected image object starts and a rendering band where the drawing of the detected image object ends. The drawing of the decoding band “c” starts in the rendering band 3 of the region 1 and ends in the rendering band 4 of the region 2. The drawing of the decoding band “d” starts in the rendering band 4 of the region 2 and ends in the rendering band 5 of the region 2.

In step S1105, the task generation unit 509 determines whether the detected image object is already decoded based on the usage state of the decoding buffer updated in step 1102. If it is determined that the detected image object is already decoded in the decoding buffer (Yes in step S1105), the task generation unit 509 skips the precedent task generation processing. The operation returns to step S1103, in which the task generation unit 509 repeats detecting the next image object. If it is determined that the detected image object is not yet decoded (No in step S1105), the operation proceeds to step S1106.

According to the example illustrated in FIG. 7B, the decoding band “c” to be drawn in the rendering band 4 of the region 2 is also drawn in the rendering band 3 of the region 1. Therefore, the decoding band “c” is already decoded before the precedent task is executed and remains in the decoding buffer. Accordingly, the decoding band “c” is not designated as a precedent task target. On the other hand, not releasing the decoding result of the decoding band “c” from the decoding buffer 304 is required until the rendering processing for the rendering band 4 completes, because the decoding band “c” is continuously drawn in the rendering band 4 of the region 2 after completing the rendering of the region 1. In step S1105, the decoding buffer management unit 506 stores information about the decoding band that is continuously drawn in the succeeding region, such as the decoding band “c”. The information about the decoding band that is continuously drawn in the succeeding region can be referred to in step S1105 to generate intermediate data for the region 2. If the data to be referred to later remains in the decoding buffer, the apparatus skips the processing for generating compression data of its decoding band and prevents the data to be referred to later from being overwritten.

In the next step S1106, the task generation unit 509 determines whether the target decoding band to be subjected to the precedent task generation processing is decodable, at the completion timing of the decoding for the decoding bands of the region 1. In the present exemplary embodiment, there is not any available capacity in the decoding buffer 304 at the completion timing of the decoding of the decoding band “c”. Therefore, in step S1106, the task generation unit 509 determines that the target decoding band is not decodable.

If it is determined that the target decoding band is not decodable (No in step S1106), then in step S1107, the decoding buffer management unit 506 detects a drawing end band of the image object currently using the buffer. In step S1108, the task generation unit 509 detects the next timing when the decoding buffer 304 becomes decodable. According to the example illustrated in FIG. 7B, after the completion of the decoding of the decoding band “c”, if the task of the rendering band 2 of the region 1 completes, the image data of the decoding band “a” is no longer required. Accordingly, a significant amount of capacity of the decoding buffer 304 becomes available.

In step S1109, the precedence propriety checking unit 510 checks if the precedent task generation is possible. More specifically, the precedence propriety checking unit 510 checks if the capacity available timing detected in step S1108 is earlier than the termination of the rendering processing for the region 1. According to the example illustrated in FIG. 7B, it can be determined that the capacity available timing is earlier than the completion of the rendering task of the region 1. Therefore, the precedence propriety checking unit 510 determines that generating a precedent task is possible.

If it is determined that the precedent task generation is possible (Yes in step S1109), then in step S1110, the compression data generation unit 504 generates compression image data of a precedent task target decoding band, as a precedent decoding band of the region 2. Further, in step S1111, the task generation unit 509 generates a task of the precedent task target decoding band. In the present exemplary embodiment, the precedent task target decoding band “d” becomes decodable after the processing for the rendering band 3 starts. Therefore, the task generation unit 509 associates the precedent task “d” with waiting ID3.

In step S1112, the task generation unit 509 adds precedent compression data not drawn in the region 1 to the already generated compression data of the region 1. Further, the task generation unit 509 adds the precedent task to the decoding schedule of the region 1.

Finally, in step S1113, the usage state of the decoding buffer 304 at the completion timing of the added precedent task is updated with reference to the information stored in the decoding buffer management unit 506.

After completing the addition of the precedent task, the operation returns to step S1103. In step S1103, the task generation unit 509 repeats detecting an image object. If it is determined that the object detected in step S1108 is not precedently decodable, or if it is determined that no image object is detectable (No in step S1103), the operation proceeds to step S1114 in which the precedent task generation completes.

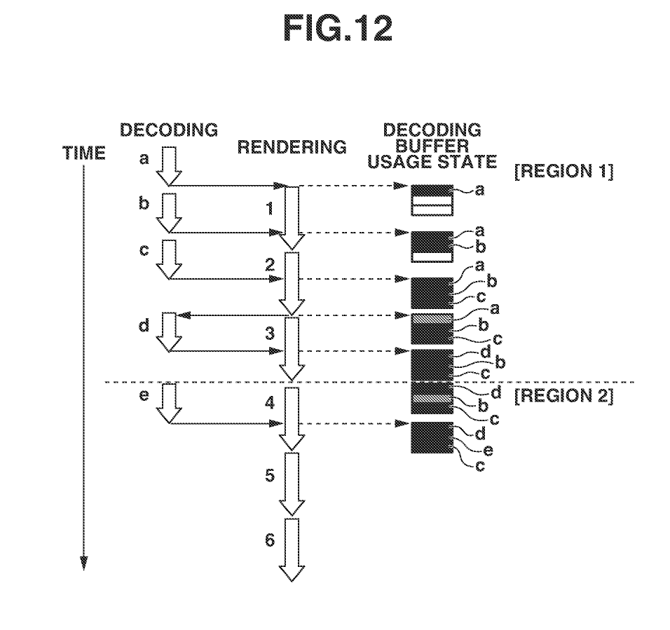

As mentioned above, the processing according to the present exemplary embodiment includes generating intermediate data in such a way as to precedently perform decoding processing for a region for which intermediate data is to be next generated, including decoding processing not contributing to the drawing in a region for which intermediate data is presently generated. FIG. 12 illustrates rendering processing and decoding processing performed in the case where the generation of intermediate data is performed for each region according to the above-mentioned processing flow. Because of the processing for precedently decoding the decoding band “d”, the rendering unit can start rendering processing for the rendering band of the region 2 without waiting for the decoding processing.

As mentioned above, generating intermediate data for each of a plurality of regions obtained by dividing one page brings an effect of lowering the cost of the intermediate data buffer 507. Further, in a case where an image object straddles a plurality of regions, the processing according to the present invention includes detecting a decoding band to be drawn in the next region and precedently decoding the detected decoding band considering the usage state of the decoding buffer. Therefore, it is possible to prevent the processing efficiency from deteriorating due to waiting. Further, managing the availability of the decoding buffer based on the dependence relationship between the rendering and the decoding can eliminate generation of a compression image that cannot be precedently decoded and addition of a related task. Therefore, the processing time for generating redundant intermediate data can be reduced. The size of intermediate data can be presented from becoming excessively larger. Further, because of the capability of reading intermediate data with reference to the dependence relationship between the rendering and the decoding, the raster image data generation unit can process intermediate data with a simply configuration that is free from management of the decoding buffer and analysis of dependency.

In the first exemplary embodiment, the PDL processing unit 105 and the raster image data generation unit 106 are functionally operable as an information processing apparatus and are incorporated in the image forming apparatus 100. However, a part or the whole of the information processing apparatus can be configured as an independent unit (or apparatus) that does not include any output unit capable of performing printing. For example, the PDL processing unit 105 can be realized as software for a personal computer (PC) or an information terminal, such as a tablet. In this case, if a target image forming apparatus having a printing function is identified, the PDL processing unit 105 performs PDL processing according to the target image forming apparatus.

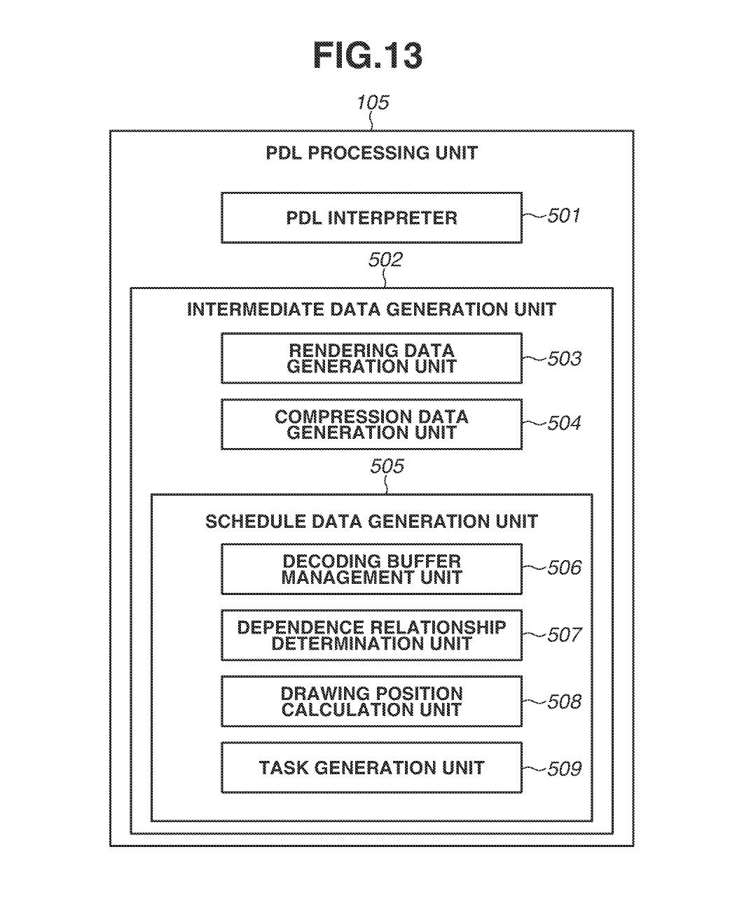

The above-mentioned first exemplary embodiment includes initially generating a decoding schedule required for a target region and subsequently generating a precedent task, based on the usage state of the decoding buffer 304, with reference to PDL data of a region for which intermediate data is to be next generated. A second exemplary embodiment provides a method for precedently generating compression data and decoding task by continuously generating compression data to be next decoded irrespective of drawing region if there is any available capacity in the decoding buffer 304, as described in detail below. FIG. 13 is a block diagram illustrating a detailed configuration of the PDL processing unit 105 according to the second exemplary embodiment. In the second exemplary embodiment, the precedence propriety checking unit 510 is not required, because the PDL processing unit 105 is configured to generate a decoding task if the decoding buffer 304 has an available capacity. The same reference number is used to denote a constituent component if it is similar to that described in the first exemplary embodiment, and redundant description thereof will be avoided.

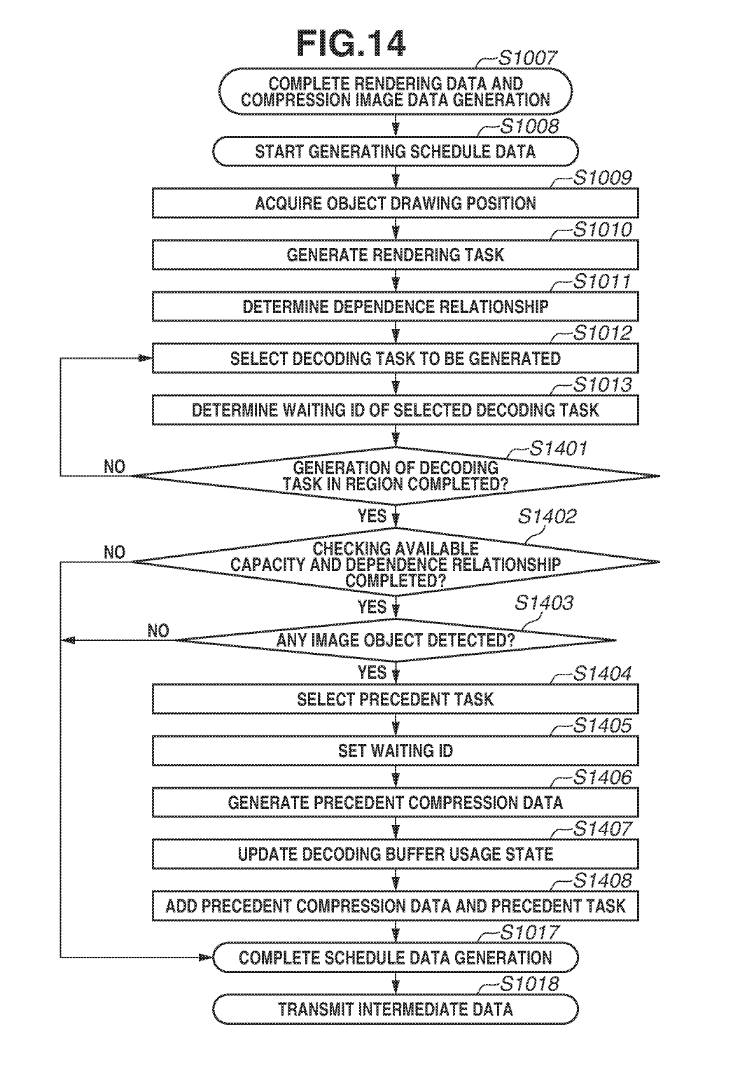

FIG. 14 is a flowchart illustrating intermediate data generation processing according to the second exemplary embodiment. Processing to be performed in steps S1401 to S1408 will be described in detail below.

First, in step S1401, the task generation unit 509 determines whether the decoding task generation for each image object to be drawn in the interested region has been completed. If the task generation unit 509 determines that the task generation for all decoding bands is not yet completed (No in step S1401), the operation returns to step S1010. If the task generation unit 509 determines that the task generation for all decoding bands of each image object to be drawn in the interested region has been completed (Yes in step S1401), the operation proceeds to step S1402.

In step S1402, the task generation unit 509 confirms the usage state of the decoding buffer 304 at the completion timing of the decoding processing for all decoding bands. If there is not any available capacity in the decoding buffer 304, the task generation unit 509 further refers to the dependence relationship of each decoding band included in the generated task. If there is a decoding band included in the rendering band that is no longer referred to although there is an available capacity at the completion timing of the decoding processing for all decoding bands, the operation proceeds to step S1402. If there is not any available capacity at the completion timing of the decoding processing for all decoding bands and if there is not any decoding band included in the rendering band that is no longer referred to, it means that the decoding band cannot be brought into an overwritable state until the rendering processing in each region completes. Accordingly, precedently decoding the decoding band of an image object to be drawn in the next region is impossible. Therefore, in step S1015, the task generation unit 509 completes the generation of schedule data.

In step S1403, the compression data generation unit 504 detects an image object in a region following the interested region for which intermediate data is to be generated. If there is not any image object in the region following the interested region (No in step S1403), the operation proceeds to step S1015. The intermediate data generation unit 502 completes the processing of the flowchart illustrated in FIG. 14. If an image object has been detected (Yes in step S1403), the compression data generation unit 504 identifies the decoding band. The operation proceeds to step S1404.

In step S1404, the task generation unit 509 selects the decoding band detected in step S1403 as a precedent task. In step S1405, the task generation unit 509 sets waiting ID that indicates the generation timing of available capacity in the decoding buffer 304 while the rendering of the interested region is in progress in step S1402.

In step S1406, the compression data generation unit 504 generates compression data of the decoding band identified in step S1403. In step S1407, the intermediate data generation unit 502 updates the usage state of the decoding buffer 304. In step S1408, the intermediate data generation unit 502 adds the compression data generated in step S1406 to the compression data. The intermediate data generation unit 502 adds the task generated in step S1405 to the decoding schedule.

According to the above-mentioned processing, when the intermediate data generation unit 502 generates intermediate data for each divided region of the print page, the processing target with respect to the rendering data and the rendering schedule is limited within the same region. On the other hand, the generation of compression data of a drawing object and a related decoding schedule includes an image object in another region depending on the usage state of the decoding buffer. The above-mentioned processing precedently starts decoding compression data of an image object in a region other than the interested region if any one of decoding bands in the decoding buffer becomes available for overwriting. As a result, the decoding buffer is brought into a state where the compression data required for subsequent rendering can be successively and promptly decoded. Thus, it becomes possible to reduce decoding wait time that may occur when the intermediate data is generated for each region.

According to the above-mentioned configuration of the first exemplary embodiment, the decoding start control is triggered by the processing in step S904 for determining whether to start the processing for the target rendering band. A third exemplary embodiment provides a method for concurrently generating a decoding start instruction and a rendering start instruction, as described in detail below. The same reference number is used to denote a constituent component if it is similar to that described in the first exemplary embodiment, and redundant description thereof will be avoided.

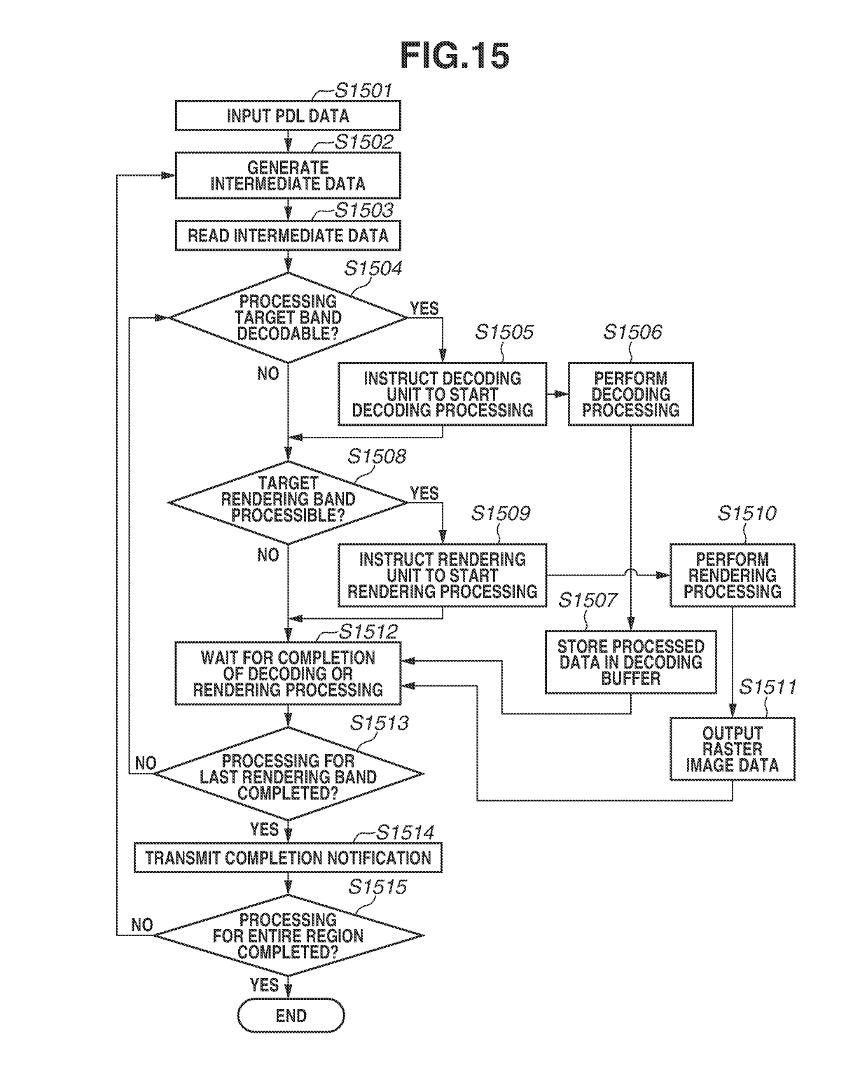

FIG. 15 is a flowchart illustrating entire processing performed by the PDL processing unit 105 and the raster image data generation unit 106 according to the third exemplary embodiment.

Processing to be performed in steps S1501 to S1503, i.e., processing for completing the reading of intermediate data, is similar to the processing performed in steps S901 to S903 described in the first exemplary embodiment. Therefore, redundant description thereof will be avoided.

In step 1504, the control unit 301 reads a decoding task to be processed with reference to a decoding schedule included in the read intermediate data and determines a processing target decoding band. The control unit 301 determines whether starting decoding processing for the processing target decoding band is possible based on waiting ID of the task. If the control unit 301 determines that the waiting ID is 0 or the rendering processing indicated by the waiting ID is already completed (Yes in step S1504), the operation proceeds to step S1505.

In step S1505, the control unit 301 instructs the decoding unit 303 to start the decoding processing for the processing target decoding band. In this case, the control unit 301 does not wait for the notification of completion. The operation proceeds to step S1508. Further, if it is determined that the rendering processing indicated by the waiting ID is not yet completed (No in step S1504), the control unit 301 does not instruct the decoding unit 303 to start the decoding processing. The operation proceeds to step S1508.

In step S1506, the decoding unit 303 reads compression data included in the intermediate data according to an instruction from the control unit 301 and performs decoding processing for the instructed decoding band. In step S1507, the decoding unit 303 stores image data obtained through the decoding processing in the decoding buffer 304. If the decoding processing completes, the decoding unit 303 notifies the control unit 301 of completion of decoding.

In step S1508, the control unit 301 reads a task to be processed with reference to a rendering schedule included in the read intermediate data and determines a processing target rendering band. The control unit 301 determines whether it is possible to start rendering processing for the processing target rendering band with reference to waiting ID of the task. If the control unit 301 determines that the waiting ID is 0 or if the decoding processing for the decoding band indicated by the waiting ID is already completed (Yes in step S1508), the operation proceeds to step S1509.

In step S1509, the control unit 301 instructs the rendering unit 302 to start the rendering processing for the processing target rendering band. In this case, the control unit 301 does not wait for the notification of completion. The operation proceeds to step S1512. Further, if it is determined that the decoding processing for the decoding band indicated by the waiting ID is not yet completed (No in step S1508), the control unit 301 does not instruct the rendering unit 302 to start the rendering processing. The operation proceeds to step S1512.

In step S1512, the control unit 301 waits for a completion notification about the decoding processing instructed in step S1505 or a completion notification about the rendering processing instructed in step S1509. If the control unit 301 detects any one of these completion notifications, then in step 1513, the control unit 301 determines whether the processing for the last rendering band has been completed. If the control unit 301 determines that the rendering processing is in progress or there is an unprocessed rendering band (No in step S1503), the operation returns to step S1504. In step S1504, the control unit 301 performs processing for the next decoding band or the next rendering band. If the control unit 301 detects the completion of the processing for the last rendering band, the control unit 301 transmits a completion notification because the intermediate data buffer 507 becomes available for overwriting.

In step 1515, the PDL generation unit 102 determines whether the generation of intermediate data has been completed for the entire region of the print page. If the PDL generation unit 102 determines that there is a region for which the generation of intermediate data is not yet completed (No in step S1515), the operation returns to step S1502. The PDL processing unit 105 generates intermediate data of the next region.

As mentioned above, controlling in such a way as to perform decoding processing or rendering processing if starting the processing is possible while waiting for the completion of processing having a dependence relationship, it is possible to concurrently generate the decoding start instruction and the rendering start instruction. As a result, it is possible to reduce the waiting time for the rendering processing as well as the waiting time for the decoding processing.

In the above-mentioned exemplary embodiments, the control unit 301 is configured to instruct the rendering unit 302 and the decoding unit 303 to start processing. However, as a modified embodiment, the control unit 301 can be constituted by two control units that are operable independently. For example, a rendering control unit that instructs the rendering unit 302 to start rendering processing and a decoding control unit configured to instruct the decoding unit 303 to start decoding processing can be independently provided, so that the processing starts of the rendering processing and the decoding processing can be concurrently instructed.

In the above-mentioned exemplary embodiments, there is not any restriction with respect to the region for which compression data is to be precedently generated. However, in a case where an image object to be drawn is not included in the region, it may be useful to provide appropriate restriction. For example, terminating the generation of compression image data 212 may be useful if precedent compression data is not generated or the decoding buffer has no available capacity even at the completion timing of the processing for succeeding two regions.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-115173, filed Jun. 5, 2015, and No. 2016-081489, filed Apr. 14, 2016, which are hereby incorporated by reference herein in their entirety.

What is claimed is:

1. An information processing apparatus that converts input print data representing a print target image into raster image data, the apparatus comprising:
a decoding unit configured to decode coded compression data of an image object to be drawn in the image based on the print data;
a first storing unit configured to store image data of the image object obtained as a result of the decoding of the compression data by the decoding unit; and
a rendering unit configured to generate raster image data by performing rendering for each region of the image with reference to the image data of the image object stored by the storing unit,
wherein, while the rendering unit generates raster image data for an interested region, the decoding unit decodes compression data of an image object to be drawn in the interested region and at least a part of compression data of an image object to be drawn in a region following the interested region.

2. The information processing apparatus according to claim 1, further comprising:
an interpretation unit configured to interpret the print data and convert the interpreted print data into a drawing command; and
an intermediate data generation unit configured to generate intermediate data including compression data of the image object to be drawn in the image and rendering data of the image, for each region, according to the drawing command,
wherein the decoding unit decodes the compression data included in the intermediate data,
wherein the rendering unit renders the rendering data, and
wherein the intermediate data generation unit generates, for the interested region, intermediate data including rendering data of the interested region to be processed by the rendering unit, the compression data of the image object to be drawn in the interested region, and at least a part of the compression data of the image object that is not to be drawn in the interested region but is to be drawn in the region following the interested region for which intermediate data is to be generated.

3. The information processing apparatus according to claim 2,
wherein the rendering unit performs rendering processing for each rendering band and the decoding unit performs decoding processing for each decoding band, and
wherein the intermediate data generation unit generates, for the interested region, schedule data indicating a timing at which the rendering unit can start the rendering processing for each rendering band and schedule data indicating a timing at the decoding unit can start the decoding processing for each decoding band.

4. The information processing apparatus according to claim 3, wherein the intermediate data generation unit includes:
a unit configured to manage a usage state of the first storing unit;
a calculation unit configured to calculate a drawing position, at which the image object is to be drawn, in the print data;
a determination unit configured to determine a correspondence relationship between each decoding band and a rendering band in which image data of the decoding band is no longer referred to, based on the drawing position;
a checking unit configured to check whether an image object to be drawn in a region other than the interested region is precedently decodable, based on the usage state and the correspondence relationship; and
a task generation unit configured to generate a task including identification information about a decoding band in association with waiting ID representing identification information about a rendering band whose rendering completion should be waited before starting the processing for the decoding band,
wherein, in a case where the checking unit determines that the image object to be drawn in the region other than the interested region is precedently decodable, the task generation unit generates at least a part of the compression data of the image object that is not to be drawn in the interested region but is to be drawn in the region following the interested region for which intermediate data is to be generated, based on the usage state, and generates a decoding task to control a decoding start timing of the compression data.

5. The information processing apparatus according to claim 4, wherein the task generation unit generates a rendering task including an identification number of a rendering band in association with an identification number of the last decoding band whose decoding processing should be completed before starting the rendering processing for the rendering band.

6. The information processing apparatus according to claim 5, further comprising a control unit configured to read the intermediate data and control the rendering unit and the decoding unit according to the decoding task and the rendering task included in the intermediate data.

7. The information processing apparatus according to claim 1, wherein the compression data of the image object to be drawn in the region following the interested region is compression data to be used for drawing in only the region following the interested region.

8. The information processing apparatus according to claim 2,
wherein the intermediate data generation unit determines whether the compression data of the image object to be drawn in the interested region includes compression data decoded in a preceding region that is a region following the interested region for which intermediate data is to be generated, and
wherein, in a case where the compression data of the image object to be drawn in the interested region includes the compression data decoded in the preceding region, the compression data decoded in the preceding region that is the region following the interested region, for which intermediate data is to be generated, is prevented from being included in the intermediate data of the interested region.

9. The information processing apparatus according to claim 2, further comprising a second storing unit configured to store the intermediate data,
wherein the second storing unit is capable of storing intermediate data of only one of the plurality of regions.

10. A computer-readable storage medium storing a computer program that is read by a computer and causes the computer to function as the information processing apparatus according to claim 1.

11. An information processing method for converting input print data representing a print target image into raster image data, the method comprising:
decoding coded compression data of an image object to be drawn in the image based on the print data; and
generating raster image data by performing rendering for each region of the image with reference to image data of the image object,
wherein, while the rendering generates raster image data of an interested region, the decoding includes decoding compression data of an image object to be drawn in the interested region and at least a part of compression data of an image object to be drawn in a region following the interested region.
